(19) United States
(12) Patent Application Publication
(10) Pub. No.: US 2010/0264683 A1
(43) Pub. Date: Oct. 21, 2010

(54) CENTER STACK

(75) Inventor: Lasse ARO, Vasa (FI)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/637,347

(22) Filed: Dec. 14, 2009

(30) Foreign Application Priority Data
Dec. 18, 2008 (GB) 0823104.5

(51) Int. Cl. B60R 7/06

(52) U.S. Cl. 296/37.12

(57) ABSTRACT

A center stack is provided for a vehicle that includes, but is not limited to a housing and a panel that includes, but is not limited to operating elements, preferably for an audio system and/or an air conditioning system. The panel is movable to a closed position and to an opened position and the housing comprises a glove box with an opening to a passenger compartment of the vehicle. The opening of the glove box is completely covered by the panel in the closed position of the panel and the opening of the glove box is accessible from the passenger compartment in the opened position of the panel. With the inventive center stack it is possible to provide a center stack for a vehicle which is very functional and increase the safety of a c-driver in case of a crash.

### CROSS-REFERENCE TO RELATED APPLICATION

This application claims priority to British Patent Application No. 0823104.5, filed Dec. 18, 2008, which is incorporated herein by reference in its entirety.

### TECHNICAL FIELD

The invention relates to a center stack for a vehicle.

### BACKGROUND

Inside the passenger compartment of a vehicle a dashboard is arranged comprising a glove box for storing articles like maps, handbags, keys, music CDs or something else positioned near to the co-driver seat. Because of positioning the glove box near to the co-driver seat it is difficult for the driver to reach the glove box since the glove box is positioned far away for the driver. Especially if the driver is alone in the vehicle without any other passengers it is difficult for him to use the glove box, since nobody can help him using the glove box. Moreover, the glove box represents a danger for the co-driver in case of a crash since a normal glove box does not provide much reinforcement. Due to that the glove box, especially the lid of the glove box, easily may create dangerous splits in the knee impact zone of the co-driver in case of a crash which may cause severe injuries to the co-driver.

It is already known to provide a storage compartment in a center stack of a vehicle for storing articles. But this space is very small so that only very small articles may be stored inside this space. Therefore, disadvantageously a glove box positioned in the dashboard is additionally needed.

It at least one object of the invention to provide a center stack for a vehicle which is very functional and increases the safety of a co-driver in case of a crash. In addition, other objects, desirable features, and characteristics will become apparent from the subsequent summary and detailed description, and the appended claims, taken in conjunction with the accompanying drawings and this background.

### SUMMARY

The center stack according to an embodiment of the invention comprises a housing and a panel comprising operating elements preferably for an audio system and/or an air conditioning system. The panel is movable to a closed position and to an opened position and the housing comprises a glove box with an opening to a passenger compartment of the vehicle, whereas the opening of the glove box is completely covered by the panel in the closed position of the panel and the opening of the glove box is accessible from the passenger compartment in the opened position of the panel.

Advantageously, the glove box is now positioned in the center stack of the vehicle and not anymore in the dashboard of the vehicle. By positioning the glove box in the center stack the glove box is easily reachable for the driver. The glove box is arranged inside a housing in the area of operating elements, like operating elements for an audio system, an air conditioning system and/or other systems needed in the vehicle, which are positioned at the center stack. The operating elements are positioned on a panel which reaches about a big-sized area of the center stack, preferably reaches about almost the whole length and width of the center stack. By moving away the electrical boxes from the center stack in the area of the operating elements, where they are normally positioned, it is possible to position the glove box in the center stack in the area of the operating elements. The electrical boxes are preferably now positioned in the dashboard. It is possible to form the glove box about the same length and same width of the panel, so that a lot of space is provided for the glove box. Thus, the glove box positioned in the center stack is suitable for storing larger articles, like handbags or maps, and the glove box does not only constitute a small storage space for small articles.

The panel is movable in a closed position and in an opened position. The glove box comprises an opening to the passenger compartment of the vehicle, whereas the opening of the glove box is completely covered by the panel in the closed position of the panel and the opening of the glove box is accessible from the passenger compartment in the opened position of the panel. Since the panel is preferably constructed very thin, the panel may have the function of a lid for the opening of the glove box. Since the panel functions as a lid at least one component part less is needed as normally. Moreover, the panel provides a much better reinforcement than a normal lid especially in case of a crash.

According to a preferred embodiment of the invention, the glove box provides a margin adjoined to the housing, whereas the margin of the glove box is flushed with the margin of the panel in the closed position of the panel. The margin of the glove box describes the scope of the glove box, especially the scope of the opening of the glove box. The margin of the panel describes the length and the width of the panel. By flushing with the margin of the panel, the glove box may fully utilize the whole length and width of the panel so that the glove box provides a lot of space for stored articles. Additionally, the glove box may be closed fully to the passenger compartment by the panel in the closed position of the panel.

Preferably, the panel is mounted to the housing by at least two movable arm elements, whereas the panel performs a linear movement relative to the surface of the center stack adjoined to the passenger compartment by moving the panel in the closed position and in the opened position. The movable arm elements are preferably positioned opposite to each other at the lateral surfaces of the panel. A movable arm element preferably consists of a plain bended sheet element which is at one side mounted to the panel and at the other side mounted to the housing or to the glove box. By using these movable arm elements the movement of the panel is easily realizable and only few construction elements are needed for realizing the movement. Preferably, the panel performs a linear movement relative to the surface of the center stack adjoined to the passenger compartment by moving the panel in the closed position and in the opened position. By this linear movement the panel may be guided close to the surface of the center stack, so that the movement of the panel does not need a lot of space and the passengers in the vehicle are not bothered by the movement of the panel. Furthermore, the panel and the glove box can be positioned at any place of the center stack, especially in the middle of the center stack, since the panel does not have to perform a rotary movement.

The movable arm element is preferably mounted to the housing or to the glove box by a first joint element and preferably mounted to the panel by a second joint element. The joint elements provide a good and easy movability of the panel to the closed position and to the opened.

Further, the embodiments of the invention relate to a passenger compartment of a vehicle comprising a dashboard and a center stack, preferably a center stack as previously described, whereas a glove box suitable for positioning in a dashboard is positioned in the center stack and electrical boxes suitable for positioning in the center stack are positioned inside the dashboard. By moving the electrical boxes normally positioned in the center stack in the area of the operating elements a lot of space in the center stack is provided for the glove box. By positioning the glove box in the center stack the glove box is easily reachable for the driver and the safety for the co-driver in case of a crash is raised since the electrical boxes may be positioned in the dashboard without a lid which could be splitting in the knee impact zone of the co-driver.

### BRIEF DESCRIPTION OF THE DRAWINGS

The present invention will hereinafter be described in conjunction with the following drawing FIGURE, and:

FIG. 1 is a schematic view of an inventive center stack for a vehicle according to preferred embodiment.

### DETAILED DESCRIPTION

The following detailed description is merely exemplary in nature and is not intended to limit application and uses. Furthermore, there is no intention to be bound by any theory presented in the preceding background or summary or the following detailed description.

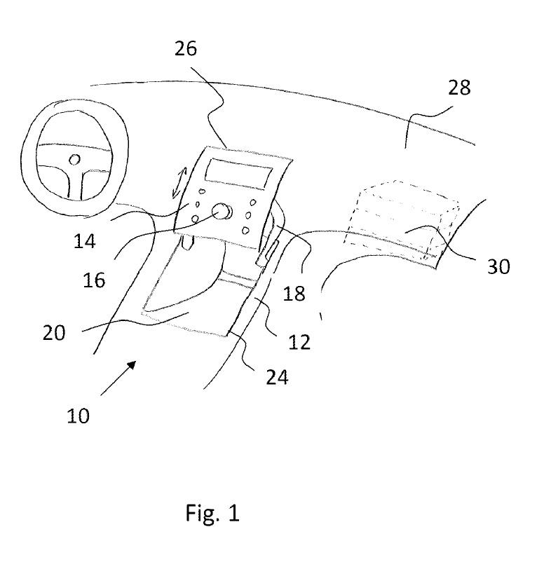

FIG. 1 shows an inventive center stack 10 for a vehicle according to a preferred embodiment comprising a housing 12 and a thin shaped panel 14. The panel 14 comprises operating elements 16, preferably for an audio system and an air conditioning system. The panel 14 is movable to a closed position and to an opened position by movable arm elements 18.

In FIG. 1 the panel 14 is shown in an opened position. The housing 12 of the center stack 10 comprises a glove box 20 with an opening to the passenger compartment 22 of the vehicle. In the opened position of the panel 14 the opening of the glove box 20 is accessible from the passenger compartment 22. In the closed position of the panel 14 the glove box 20 is completely covered by the panel 14, whereas the panel 14 functions as lid for the glove box 20.

For using the space for storing articles in the glove box 20 most optimal, the margin 24 of the glove box 20 is flushed with the margin 26 of the panel 14 in the closed position of the panel 14.

As it is shown in FIG. 1, the panel 14 performs a linear movement (shown by an arrow) relative to the surface of the center stack 10 adjoined to the passenger compartment 22 by moving the panel 14 to the closed position and to the opened position. For realizing the linear movement the movable arm elements 18, which are formed as a plain bended sheet elements, are mounted to the housing 12 or the glove box 20 by a first joint element and to the panel 14 by a second joint element.

The center stack 10 adjoins to a dashboard 28. Normally the glove box is positioned in the dashboard 28 in the area of the co-driver seat. According to an embodiment of the invention, the glove box 20 is positioned in the center stack 10 and the remaining place in the dashboard 28 is filled by electrical boxes 30, as shown in FIG. 1.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A center stack for a vehicle, comprising:
a housing comprising a glove box with an opening to a passenger compartment of the vehicle; and
a panel comprising operating elements and movable to a closed position and to an opened position, wherein the opening of the glove box is substantially covered by the paneling the closed position and the opening of the glove box is accessible from the passenger compartment in the opened.

2. The center stack according to claim 1, wherein, the glove box provides a margin adjoined to the housing and the margin of the glove box is flush with a second margin of the panel in the closed position of the panel.

3. The center stack according to claim 1, wherein the panel is mounted to the housing by at least two movable arm elements and the panel performs a linear movement relative to a surface of the center stack adjoined to the passenger compartment by movement of the panel in the closed position and in the opened position.

4. The center stack according to claim 3, wherein the first movable arm element of the at least two movable arm elements is mounted to the housing by a first joint element and a second movable arm element of the at least two movable arm elements is mounted to the panel by a second joint element.

5. A passenger compartment of a vehicle, comprising:
a dashboard adapted to receive electrical boxes;
a housing comprising a glove box suitable for positioning in the dashboard, the glove box having an opening to the passenger compartment of the vehicle; and
a panel comprising operating elements and movable to a closed position and to an opened position, wherein the opening of the glove box is substantially covered by the panel in the closed position and the opening of the glove box is accessible from the passenger compartment in the opened.

6. The passenger compartment according to claim 5, wherein, the glove box provides a margin adjoined to the housing and the margin of the glove box is flush with a second margin of the panel in the closed position of the panel.

7. The passenger compartment according to claim 5, wherein the panel is mounted to the housing by at least two movable arm elements and the panel performs a linear movement relative to a surface of a center stack adjoined to the passenger compartment by movement of the panel in the closed position and in the opened position.

8. The passenger compartment of claim 7, wherein a first movable arm element of the at least two movable arm elements is mounted to the housing by a first joint element and a second movable arm element of the at least two movable arm elements is mounted to the panel by a second joint element.
